(19) United States
(12) Patent Application Publication
(10) Pub. No.: US 2008/0149496 A1
(43) Pub. Date: Jun. 26, 2008

(54) APPARATUS AND METHODS FOR ELECTROLYZED WATER

(76) Inventor: Douglas W. Kindred, Kennesaw, GA (US)

Correspondence Address: BRACEWELL & GIULIANI LLP, P.O. BOX 61389, HOUSTON, TX, 77208-1389, US

(21) Appl. No.: 11/962,534

(22) Filed: Dec. 21, 2007

Related U.S. Application Data
(60) Provisional application No. 60/876,698, filed on Dec. 22, 2006.
(60) Provisional application No. 60/876,855, filed on Dec. 22, 2006.

(51) Int. Cl. C02F 1/461; A01K 29/00

(52) U.S. Cl. 205/742; 119/174

(57) ABSTRACT

An apparatus and method for the production of alkaline water is provided, wherein the water, when administered to cattle, is effective for the treatment and prevention of rumen acidosis. Additionally, the alkaline water is effective for increased production of milk and increased quality of milk produced.

### PRIORITY CLAIM

This application claims priority to U.S. Patent Application No. 60/876,698, filed Dec. 22, 2006, and U.S. Patent Application No. 60/876,855, filed Dec. 22, 2006, the disclosures of which are hereby incorporated by reference in their entirety.

### BACKGROUND OF THE INVENTION

1. Field of the Invention

The present invention relates generally to electrolyzed water, and more particularly to apparatus and methods for making and using electrolyzed water.

2. Description of Related Art

Traditional electrolysis utilizes a brine solution. In traditional electrolysis processes, sodium ions (Na⁺) and chloride ions (Cl⁻) create hypochlorous acid (HOCl) in the anode chamber and sodium hydroxide (NaOH) in the cathode chamber. The sodium hydroxide solution, otherwise known as the electrolyzed alkaline solution or alkaline water, commonly has a relatively high pH of 11-12, high concentration of sodium hydroxide species of approximately 200 parts per million, and a highly negative oxygen reduction potential (ORP) of about −800 mV. The high pH results in hydroxide ions (OH⁻) being the dominate species in the competition between hydroxide ions and carbonate ions in the alkaline solution. The hydroxide species will be the primary contributor to pH when the pH is 10.3 and higher, while carbonate ions will be the primary contributor to pH when the pH is 10.2 and lower. Thus, due to the high pH of the alkaline solution produced in traditional brine electrolysis, the dominate species normally is sodium hydroxide.

### SUMMARY OF THE INVENTION

Provided herein are methods for the production of alkaline water by electrolysis, and methods for improving milk production and the quality of milk produced by cows by administering alkaline water.

In one embodiment, a method for the prevention of rumen acidosis in bovine is provided wherein the method includes the step of providing an effective amount of alkaline water to a bovine in need thereof.

In another embodiment, method to treat rumen acidosis in bovine is provided wherein the method includes the step of providing an effective amount of alkaline water to a bovine in need thereof.

In another embodiment, a method to increase the milk production of a dairy cow comprising the step of providing alkaline water to the cow.

In another embodiment, a method to increase the butter fat content of milk produced by a dairy cow comprising the step of providing alkaline water to the cow.

In another embodiment, a method to reduce the use of nutritional feed additives in the feed of bovine comprising the step of providing alkaline water to the bovine.

In another embodiment, a method of operating an electrochemical electrolysis cell is provided. The method includes the steps of: (1) introducing water free of added salt or other chemicals for increasing water conductivity into the electrochemical electrolysis cell; and (2) varying the cell operating voltage to achieve the cell current required to produce alkaline water having the desired characteristics.

In another embodiment, a method of operating an electrochemical cell is provided, the method including the steps of: (1) producing acidic water in the cell; (2) optionally blending an amount of acidic water with feed water entering the cell; and (3) producing alkaline water in the cell using the blended feed water.

In another embodiment, a method of operating an electrochemical cell is provided, the method including the steps of: (1) measuring a characteristic of alkaline water produced by the cell; (2) comparing the value of the measured characteristic with the a desired value for the characteristic; and (3) modulating a cell voltage of the cell to produce alkaline water having the desired value for the characteristic.

In another embodiment, a method for the production of sodium carbonate and sodium bicarbonate is provided, the method including the steps of: (1) treating water with a cationic exchange resin softener; and (2) electrolyzing the water in an electrochemical electrolysis cell.

In another embodiment, a method for increasing the stability of alkaline water is provided, the method including the step of adding additional, externally produced, sodium bicarbonate or other agents to water to increase the alkalinity or the TDS of feed water to an electrochemical electrolysis cell.

In another embodiment, a method to decrease the somatic cell count of milk produced by a dairy cow is provided, the method including the step of providing alkaline water to the cow.

In another embodiment, a method to decrease the raw count of milk produced by a dairy cow is provided, the method including the step of providing alkaline water to the cow.

In another embodiment, a method to decrease the milk urea nitrogen of milk produced by a dairy cow is provided, the method including the step of providing alkaline water to the cow.

### BRIEF DESCRIPTION OF THE DRAWINGS

FIG. 1 is a system diagram of an exemplary electrolyzed water generator according to the present invention.

FIG. 2 is a diagram of an exemplary generator cell of FIG. 1, according to the present invention.

FIG. 3 is a graph of milk production in pounds over time in a test herd.

FIG. 4 is a graph of percent of butter fat and protein in percent over time in the milk produced by a test herd.

FIG. 5 is a graph of milk production in pounds over time in a test herd.

FIG. 6 is a graph of milk production in pounds per cow per day in a test herd.

### DETAILED DESCRIPTION

Although the following detailed description contains many specific details for purposes of illustration, one of ordinary skill in the art will appreciate that many variations and alterations to the following details are within the scope of the invention. Accordingly, the exemplary embodiments of the invention described below are set forth without any loss of generality to, and without imposing limitations thereon, the present invention.

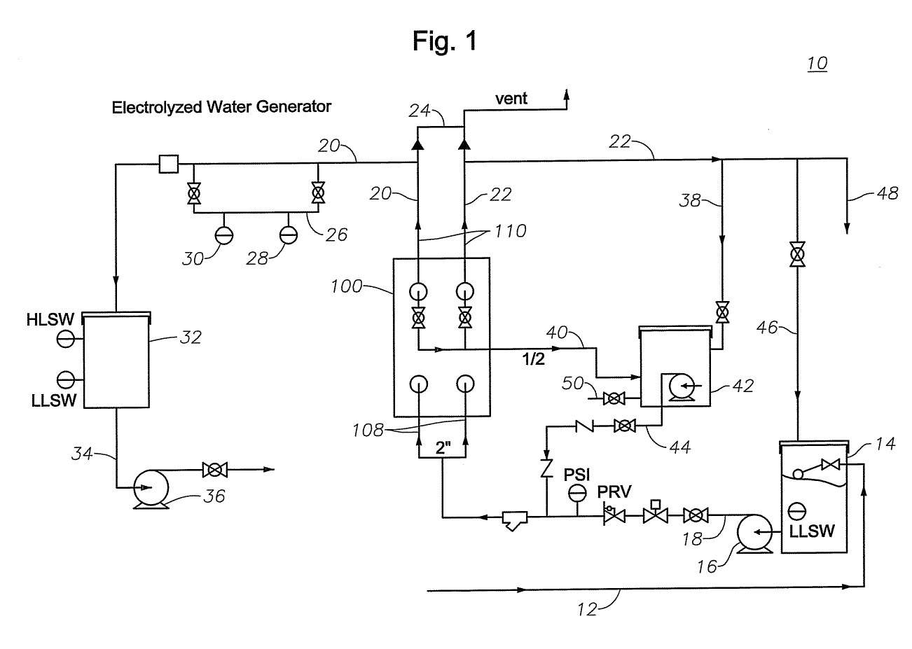

FIG. 1 is a system diagram of an exemplary system for the generation of electrolyzed water 10 according to the present invention. Softened water is supplied via line 12 to a mix tank 14, where it is mixed with acidic water discharged supplied to the mix tank via line 46. The softened water is supplied from the mix tank 14 via supply pump 16 to line 18, which supplies the water to the inlets 108 of generator cell 100 where the water is electrolyzed to produce acidic and alkaline water or solutions. Softened water is preferably used as the system is prone to plugging if water containing “hard” ions (i.e., calcium or magnesium) is used as the feed for the production of electrolyzed water according to the present invention.

Alkaline water and acidic water exit the outlets 110 of generator cell 100 via lines 20 and 22 respectively. A portion of the alkaline water in line 20 can be diverted via line 26, which can include pH probe 28 and ORP probe 30. The alkaline water is supplied to transfer tank 32, and is then supplied via line 34 and water pump 36 to an alkaline water storage tank, or optionally, directly to be consumed. The acidic water in line 22 is optionally supplied to the mix tank 14 via line 46, wherein the acidic water is mixed with softened water supplied via line 12 to adjust the pH, and then supplied to the generator cell 100. Alternatively, the acid water can be discarded via line 48. Vents are present in the generator cell 100 and allow gases generated during the electrolysis process, such as for example, oxygen and hydrogen, to be vented, thereby avoiding the presence of gas bubbles in the alkaline and acidic water lines.

The system for the generation of electrolyzed water 10 can optionally include a recirculation line for cleaning of the system. Specifically, the system can include a series of valves, allowing for the generator cell 100 to be isolated from the remainder of the system 10. A cleaning fluid recirculation tank 42 supplies a cleaning fluid, via line 44 and a portion of line 16, to generator cell 100. Exemplary cleaning fluids include muriatic acid or vinegar. The cleaning fluid is circulated via line 40, or via lines 22 and 38, back to the recirculation tank 42. The cleaning fluid is used to remove hardness deposits, plugging or the like, and to ensure efficient operation of the generator cell 100. Recirculation tank 42 includes a drain 50 for the removal of waste cleaning fluid.

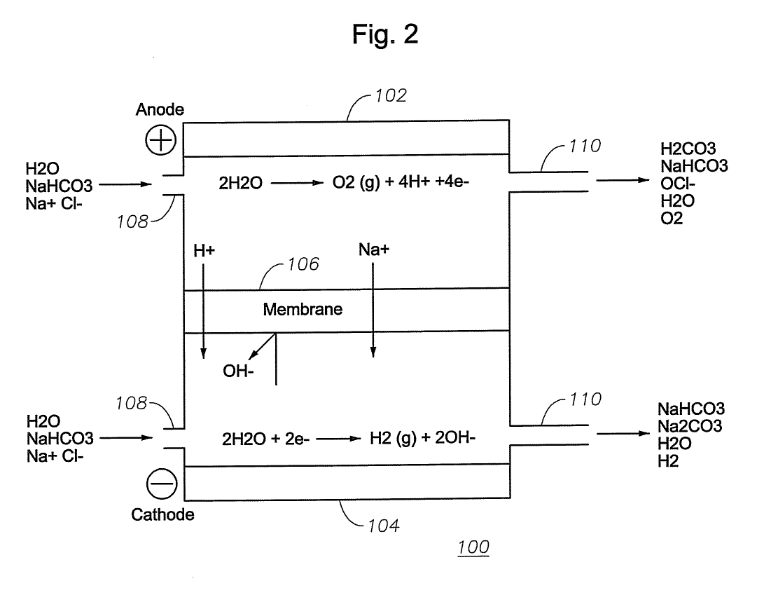

FIG. 2 is a diagram of an exemplary generator cell, as provided in of FIG. 1, according to the present invention. The generator cell 100 preferably consists of several large, flat, paired, metal plates (anodes 102 and cathodes 104) separated by a permeable membrane 106. In the generator cell 100, water enters though one or more inlets 108 located in the bottom of the generator and is directed to the respective anode 102 and cathode 104 metals where electrolysis occurs. The electrolyzed alkaline and acidic solutions then exit the generator cell via one or more outlets 110, located at the top of the generator cell 100.

The present invention also provides for methods of producing electrolyzed water. In a preferred embodiment, water, as received, is subjected to electrolysis without the addition of salt. Normal, potable water is preferably treated with cationic exchange resin softeners or other water treatment equipment, which control the hardness of the water, thereby preventing scaling and cell damage. In embodiments employing a water softener, cationic exchange resin treatment can replace most of the magnesium and calcium in the water with sodium, thus creating sodium constituents such as sodium bicarbonate in the feed water. The feed water then enters a generator cell where electrolysis occurs. Only naturally occurring salts (i.e., salts originally and naturally found in water) are involved in the electrolysis reaction because no additional salt was added to the feed water. The major constituents of the water that enter and exit the generator cell are shown in FIG. 2. Through water electrolysis, hydroxide ions (OH⁻) are created, which can then react with bicarbonate ion (HCO₃)⁻ in the water, to produce carbonate ions (CO₃)²⁻, which are typically not found in normal potable water. The concentration of carbonate ions in solutions produced by this method will vary depending on the amount of naturally occurring bicarbonate alkalinity in the feed water.

In certain embodiments, an alkaline water generator can be coupled to the feeding trough in a cattle feed lot. Water can be generated and supplied directly from the electrolysis apparatus to the cows, without requiring the intermediate storage of the water. In certain preferred embodiments, contact between electrolytically generated alkaline water and oxygen (as is found, for example, in air) is limited.

The present invention further provides for the use of electrolyzed water in agriculture. In particular, electrolyzed alkaline water, preferably electrolyzed alkaline water produced by the apparatus and method described above and having a pH of between approximately 8.0 to 10.5, preferably between approximately 8.5 and 10, more preferably between approximately 9.0 and 10.0; and having an ORP of between approximately −1000 to 100 mV, more preferably between approximately −800 and −100 mV, more preferably between approximately −800 and −200 mV, has been found to benefit the health, productivity, and milk quality of dairy cows. The effect of electrolyzed alkaline water on dairy cows was studied by providing alkaline water to cows as their sole source of drinking water. The water may be provided to cows by piping it to the cows' drinking containers. Cows receiving the alkaline water exhibited improvements in milk production of greater than 15%, and in certain embodiments, greater than 20%, as well as an increased butterfat content in the milk produced of at least 5%, and in certain embodiments at least 8%. In certain embodiments, milk production increased at least 25%. In addition, the somatic cell count of the milk is also decreased, which corresponds to milk having greater longevity and is evidenced by a healthier immune system in the treated cows. Cows receiving alkaline water typically consumed increased amounts of water, as compared to cows that were administered regular, untreated water.

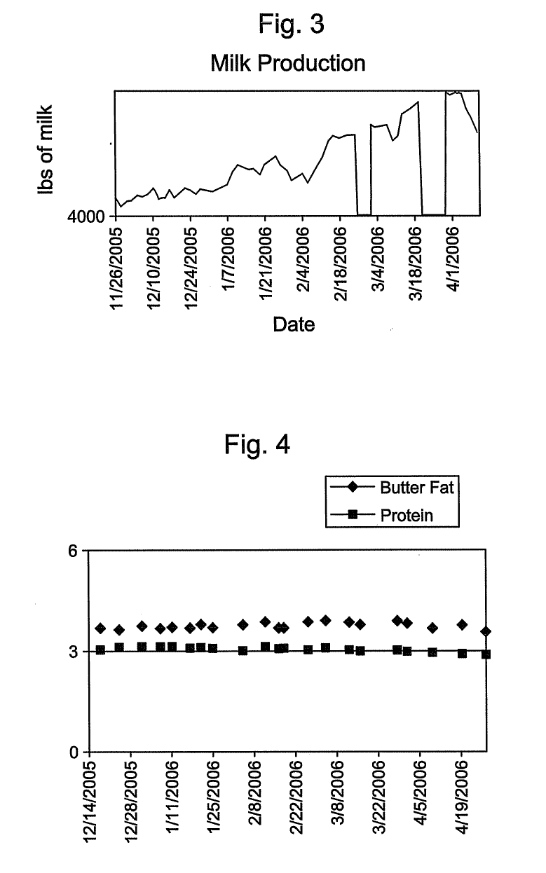

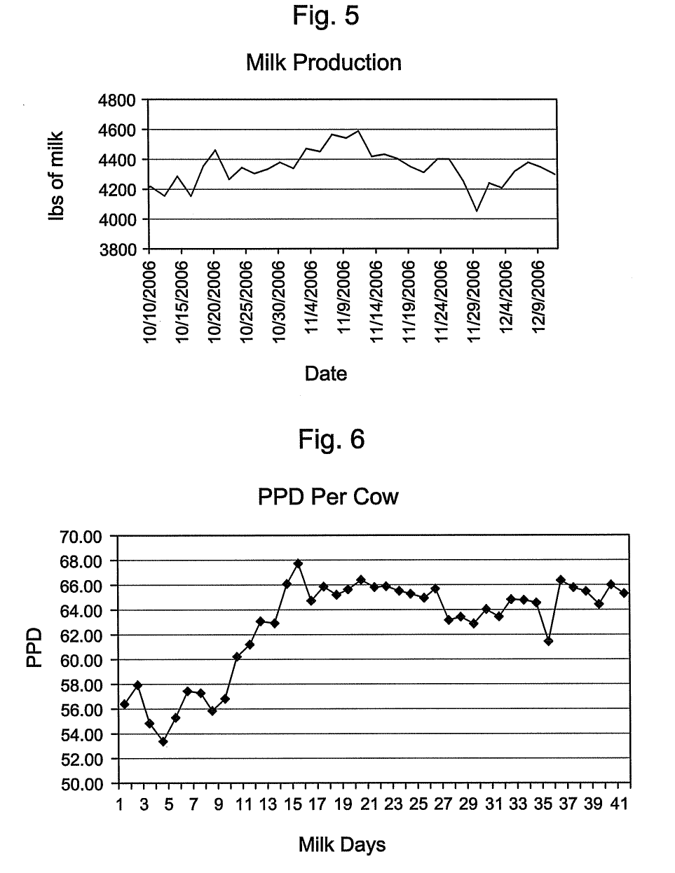

FIGS. 3, 5 and 6 are graphs showing exemplary increases in the production and quality of milk, as produced in a test herd. FIG. 4 is a graph of butter fat and protein content of the milk of the cows of a test herd. In the graphs of FIGS. 3 and 4, alkaline water was first provided to the cows of the test herd on Jan. 1, 2006. Data from the attached Production and Milk Quality Log appear in the graphs of FIGS. 3 and 4. Data from the attached Production and Milk Characteristics Log appear in the graphs of FIGS. 5 and 6.

Administration of alkaline water produced by electrolysis improves the health of cattle. Specifically, in certain embodiments, the alkaline water can be administered to cattle for both the treatment and prevention of rumen acidosis.

Because the alkaline water produced by electrolysis has an increased concentration of carbonate and bicarbonate ions, the use of nutritional feed additives can be reduced as both carbonates and bicarbonates are routinely added to cattle feed as a method to reduce incidence of acidosis. Additional bicarbonate can be added to the alkaline water to increase the stability of the alkaline water. Typically, treated alkaline water, upon exposure to oxygen, loses oxidation reduction potential. Bicarbonate ions can prevent or delay the loss of ORP.

Without being bound by any specific theory, there are several possible explanations for the positive effect of alkaline water on the health and milk production of dairy cows. First, the alkaline water has a higher pH, as compared to regular water, along with the created sodium carbonate, and thus may act as a buffer and increase the pH of the rumen of treated cows to prevent and treat rumen acidosis. Similarly, alkaline water can be administered to healthy cows for the prevention of rumen acidosis. Test data suggests that the higher pH of the alkaline water plays an important role in the treatment of the rumen acidosis. For example, in cows that were administered alkaline water, wherein the majority of the carbonate ions were removed with an anionic resin exchanger prior to administration, increased milk production was maintained. The test data suggests that the constant addition of higher-than-normal pH water to the rumen by drinking the alkaline water may cause of the increased milk production, rather than the presence of carbonate ions. Second, the alkaline water may taste better to cows, which in turn may result in increased water consumption by the cows and increased production of milk.

In another embodiment, administration of alkaline water according to the present invention is also effective to reduce the somatic cell count (SCC) in milk produced by dairy cows. SCC is the total number of cells per milliliter in milk. SCC is primarily composed of leukocytes, or white blood cells, that are produced by a cow to fight inflammation of the mammary gland, or mastitis. Because leukocytes increase as the infection worsens, SCC is a good indicator as to the degree of the infection. Thus, alkaline water prepared according to the present invention and administered to cattle is effective in treating and/or preventing mammary gland infection.

In another embodiment, administration of alkaline water according to the present invention is effective to decrease the milk nitrogen urea. Milk nitrogen urea is one way to measure the concentration of urea in a cow's blood, as the urea is freely diffusible into milk. A lower urea concentration can be indicative of a healthy rumen as rumen protein degradation is one of the sources of urea in cow blood and milk.

The tests were carried out on small dairy farms having approximately 50 to 300 cows. The qualities of the water provided to the cows in the tests were determined using an ORP meter, a pH meter, and a carbonate/hydroxide concentration test kit.

### EXAMPLE

A study was conducted over a three-month period in which 31 lactating Holstein cows were administered alkaline water produced by electrolysis with an apparatus according to the present invention. Milk production, milk fat content and milk urea, and other properties, were monitored.

The alkaline water administered to the cows was produced by electrolysis and had a pH of approximately 9.4, which was significantly higher than water administered to the control group having a pH of approximately 6.1. Additionally, the alkaline water had an increased concentration of sodium, and decreased concentrations of potassium and magnesium, relative to water administered to the control group.

Cows that were administered water produced by electrolysis exhibited increased water consumption, but did not demonstrate a noticeable increase in the consumption of feed.

Milk produced by cows that were administered the treated alkaline water showed significant increases in milk production and milk fat content, and decreased milk urea nitrogen. Specifically, administration of alkaline water produced by electrolysis increased milk production by approximately 26%. Administration of alkaline water produced by electrolysis increased milk fat content by approximately 9.4%. Administration of alkaline water produced by electrolysis decreased milk urea nitrogen by approximately 18.3%.

Additionally, it was shown that the treated alkaline water exhibited decreased coliform organisms, as compared to untreated water.

Blood chemistry of cows that were administered treated alkaline water also exhibited improved blood chemistry as blood urea nitrogen, creatinine, magnesium and chloride were all decreased. Additionally, the amount of carbon dioxide, as well as the concentration of hydroxide, bicarbonate and sodium ions, were greater in the blood of cows that were administered the treated water.

As used herein, the terms about and approximately should be interpreted to include any values which are within 5% of the recited value. Furthermore, recitation of the term about and approximately with respect to a range of values should be interpreted to include both the upper and lower end of the recited range.

Although some embodiments of the present invention have been described in detail, it should be understood that various changes, substitutions, and alterations can be made hereupon without departing from the principle and scope of the invention.

That claimed is:

1. A method to prevent rumen acidosis in bovine comprising the step of providing an effective amount of alkaline water to a bovine in need thereof.

2. The method according to claim 1 wherein the alkaline water is produced in an electrolysis cell according to the method comprising the steps of:
introducing water free of added salt or other chemicals for increasing water conductivity into the electrochemical electrolysis cell; and
varying the cell operating voltage to achieve the cell current required to produce alkaline water having the desired characteristics.

3. The method of claim 1 wherein the pH of the alkaline water is approximately 9.2 to 10.

4. The method of claims 1 wherein the oxygen reduction potential of the alkaline water is approximately −100 to −800 mV.

5. The method of claim 1 wherein the step of providing an effective amount of alkaline water to a bovine is effective to treat rumen acidosis in bovine.

6. A method to increase the milk production of a dairy cow comprising the step of providing alkaline water to the cow.

7. The method according to claim 6 wherein the alkaline water is produced in an electrolysis cell according to the method comprising the steps of:
introducing water free of added salt or other chemicals for increasing water conductivity into the electrochemical electrolysis cell; and
varying the cell operating voltage to achieve the cell current required to produce alkaline water having the desired characteristics.

8. The method of claim 6 wherein the pH of the alkaline water is approximately 9.2 to 10 and the oxygen reduction potential of the alkaline water is approximately −100 to −800 mV.

9. A method to increase the butter fat content of milk produced by a dairy cow comprising the step of providing alkaline water to the cow.

10. The method according to claim 9 wherein the alkaline water is produced in an electrolysis cell according to the method comprising the steps of:
introducing water free of added salt or other chemicals for increasing water conductivity into the electrochemical electrolysis cell; and
varying the cell operating voltage to achieve the cell current required to produce alkaline water having the desired characteristics.

11. The method of claim 9 wherein the pH of the alkaline water is approximately 9.2 to 10 and the oxygen reduction potential of the alkaline water is approximately −100 to −800 mV.

12. A method to reduce the use of nutritional feed additives in the feed of bovine comprising the step of providing alkaline water to the bovine.

13. The method according to claim 12 wherein the alkaline water is produced in an electrolysis cell according to the method comprising the steps of:
introducing water free of added salt or other chemicals for increasing water conductivity into the electrochemical electrolysis cell; and
varying the cell operating voltage to achieve the cell current required to produce alkaline water having the desired characteristics.

14. The method of claim 12 wherein the pH of the alkaline water is approximately 9.2 to 10 and the oxygen reduction potential of the alkaline water is approximately −100 to −800 mV.

15. A method to decrease the somatic cell count of milk produced by a dairy cow comprising the step of providing alkaline water to the cow.

16. A method to decrease the milk urea nitrogen of milk produced by a dairy cow comprising the step of providing alkaline water to the cow.
